(19) United States
(12) Patent Application Publication
(10) Pub. No.: US 2003/0014263 A1
(43) Pub. Date: Jan. 16, 2003

(54) Method and apparatus for efficient audio compression

(75) Inventors: Jalaludeen Ca, Alwaye (IN); Kaliamoorthy Ganesan, Trichirappalli (IN); Vaidyanathan Karthigeyan, Chennai (IN)

Correspondence Address: MENDELSOHN AND ASSOCIATES PC, 1515 MARKET STREET, SUITE 715, PHILADELPHIA, PA, 19102, US

(73) Assignee: AGERE SYSTEMS GUARDIAN CORP., Orlando, FL

(21) Appl. No.: 09/838,151

(22) Filed: Apr. 20, 2001

(51) Int. Cl. G10L 21/00; G10L 19/00

(52) U.S. Cl. 704/500

(57) ABSTRACT

The present invention provides methods and systems for efficiently compressing information, such as speech data. By generating an excitation signal containing a number of zero and non-zero values and convolving the first signal with a known transfer function, a signal such as a codec residual signal can be compressed. While a convolution between any two signals can require a large number of multiply-and-accumulate operations, convolution between an excitation signal and impulse response can be made more efficient by multiplying only the non-zero values of the excitation signal with respective values of the impulse response.

### BACKGROUND OF THE INVENTION

1. Field of Invention

This invention relates to methods and systems that compress audio information.

2. Description of Related Art

As telecommunications plays an increasingly important role in modem life, the need to provide clear and intelligible voice channels increases commensurately. However, providing clear and intelligible voice channels can require high-bit-rate communication links, which can be expensive. While bit-rates for various audio channels can be reduced by first compressing audio information before transmitting, such audio compression can require excessive processing power. Accordingly, there is a need for new technology to efficiently compress audio information while reducing processing power.

### SUMMARY OF THE INVENTION

The present invention provides methods and systems for efficiently compressing information, such as speech data. Generally, before transmission, information can be compressed, or quantized, by generating a first pulse stream that contains a number of pulses as well as a plurality of zero values, such as a multipulse-maximum likelihood quantization (MP-MLQ) excitation signal. The excitation signal can then be convolved with a second signal, such as an appropriately formed impulse response, to produce a quantized residual signal. If the quantized residual signal is sufficiently similar to a target residual signal, then the excitation signal and impulse response can be transmitted in lieu of the target residual signal. Otherwise, another excitation signal must be generated to produce another quantized residual signal until an excitation signal is generated that, when convolved with the impulse response, sufficiently resembles the target residual signal.

Generally, a convolution between any two signals can require a large number of multiply-and-accumulate operations. However, according to various embodiments, the convolution between the first and second signals can be made more efficient by multiplying only the non-zero values of the first signal with respective values of the second signal. That is, by not multiplying the zero values of the first pulse stream with respective values of the second signal, a large number of unnecessary multiply-and-accumulate operations can be avoided.

In other exemplary embodiments, the same convolution technique used to generate an excitation signal at a coder can be used to generate a quantized residual signal at a decoder. That is, by receiving an MP-MLQ excitation signal and a complimentary impulse response and then efficiently convolving the two signals, i.e., avoiding unnecessary multiply-and-accumulate operations, a quantized residual signal can be formed that, in turn, can be used to synthesize speech.

### BRIEF DESCRIPTION OF THE DRAWINGS

The invention is described in detail with regard to the following figures, wherein like numbers reference like elements, and wherein:

FIG. 1 is a block diagram of an exemplary communication system in accordance with the present invention;

FIG. 2 is a block diagram of the exemplary coder of FIG. 1;

FIG. 3 is a plot of an exemplary residual signal;

FIG. 4 is a plot of an exemplary excitation signal;

FIG. 5 is a block diagram of the exemplary quantizer of FIG. 2;

FIG. 6 is a block diagram of the exemplary decoder of FIG. 1;

FIG. 7 is a flowchart outlining an exemplary operation for quantizing a residual signal in accordance with the present invention; and

FIG. 8 is a flowchart outlining an exemplary operation for synthesizing an audio signal in accordance with the present invention.

### DETAILED DESCRIPTION OF PREFERRED EMBODIMENTS

There is obvious economic advantage in making telecommunications channels operate as inexpensively as possible. For digital communication channels such as modem long distance phone lines and cellular phone links, there is a direct correlation to the cost of a communication channel and the number of bits-per-second the communication channel requires.

Traditionally, high quality voice channels required high bit-rates. However, by efficiently compressing a voice signal before transmission, bit-rates can be lowered without noticeable degradation of the clarity and/or intelligibility of the received voice signals. One efficient compression technique is the linear predictive coding (LPC) technique, which compresses voices based on a model analogous to the human vocal system. That is, for a given time segment, or frame, of sampled speech, an LPC-based coding device can break the sampled speech into an excitation, or residual, portion that models the human larynx, and a corresponding LPC transfer function that models the human vocal tract.

By transmitting an LPC transfer function and residual signal, as opposed to transmitting the original sampled speech, the bit-rate of a communication channel can be greatly reduced. By further compressing the residual signal using a pulsed-based compression technique such as a multipulse-maximum likelihood quantization (MP-MLQ) technique, bit-rates can be further reduced.

Generally, compressing a residual signal can require synthesis of various streams of pulses known as excitation signals, and convolving each excitation signal with a known transfer function to produce a quantized residual signal. The quantized residual signal can then be compared to the original residual signal to determine whether the quantized residual signal can sufficiently represent the original residual signal. If the difference between a particular quantized residual signal and its respective original residual signal is excessive, another stream of pulses, i.e. an excitation signal, can be synthesized and convolved to produce yet another quantized residual signal, which again can be compared to the original residual signal. The process can continue until a combination of pulses is synthesized that can sufficiently represent the original residual signal.

Unfortunately, producing a quantized residual signal via convolution can be computationally expensive because generating each point in the quantized residual signal can require a large number of multiply-and-accumulate operations between an excitation signal and respective transfer function. Fortunately, however, because practical excitation signals use only a few non-zero values out of a large number of possible pulse locations, a large number of the multiply-and-accumulate operations can be avoided. For example, an MP-MLQ pulse stream contains sixty discrete locations but only requires five or six non-zero values dispersed throughout the sixty possible locations, while the remaining locations contain zero values. Because the product of anything multiplied with zero is always zero, any multiply-and-accumulate operations having a zero as an input can be avoided. Accordingly, by tracking the five or six non-zero values in an MP-MLQ excitation signal, and performing multiply-and-accumulate operations only for those five or six non-zero values, up to 65% of the multiply-and-accumulate operations inherent in conventional convolution techniques can be avoided.

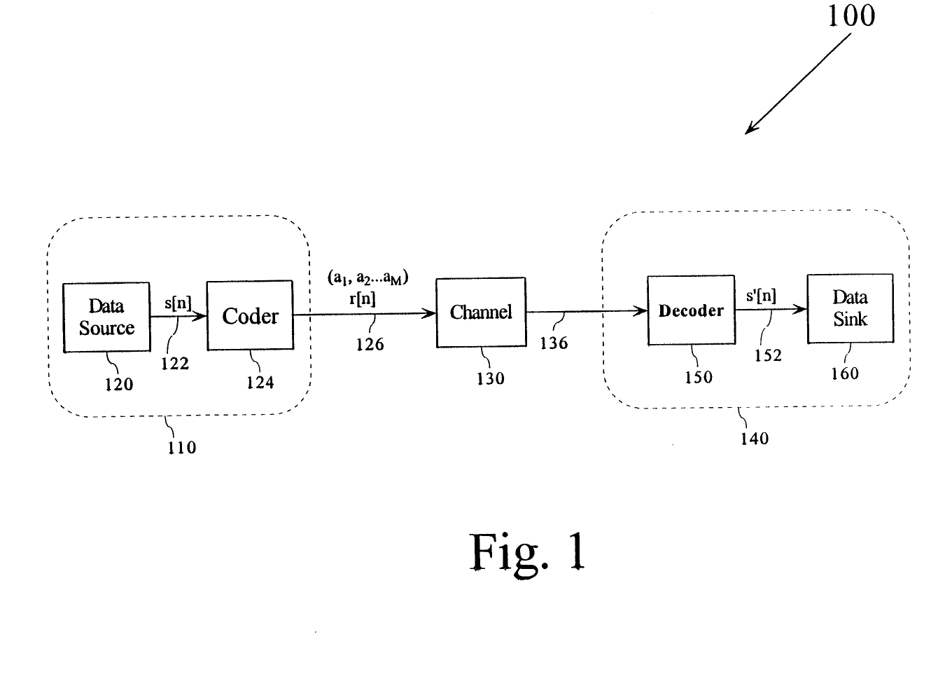

FIG. 1 shows an exemplary block diagram of a communication system 100. The communication system 100 includes a transmitter 110, a communication channel 130 and a receiver 140. The transmitter 110 has a data source 120 and a coder 124, and the receiver 140 has a decoder 150 and a data sink 160.

In operation, the data source 120 can provide audio signals, such as voice signals s[n], to the coder 124 via link 122. It is to be understood, that in various exemplary embodiments, the data source 120 can be any one of a number of different types of sources without departing from the spirit and scope of the present invention. Such data sources include a person speaking into a microphone, a computer generating synthesized speech, a storage device such as a magnetic tape, a disk drive, an optical medium such as a compact disk or any known or later-developed combination of software and hardware capable of generating, relaying or recalling from storage, any information capable of being transmitted to the coder 124. It should be further appreciated that the speech signals can be any form of speech such as speech produced by human, mechanical speech, information representing speech or any other signal or form of information that can represent speech. However, for the purposes of the discussion below, the data source 120 will be assumed to be a person speaking into the receiver of a cellular telephone.

As the coder 124 receives speech signals s[n] from the data source 120, the coder 124 can divide the speech signals into individual time frames. For example, the coder 124 can receive continuous speech signals and divide the continuous speech signals into contiguous frames of 20 msecs each. The coder 124 can then perform a linear predictive coding (LPC) analysis on each speech frame to generate LPC coefficients (a₁, a₂, . . . , a_{M}) and a residual signal r[n]. The residual signal can then be compressed by a technique known as quantization, and the LPC coefficients and quantized residual signal can then be exported to the communication channel 130 via link 126.

The exemplary coder is a dedicated signal processor with an analog-to-digital converter (ADC) and other peripheral hardware. However, the coder 124 can alternatively be a micro-processor or micro-controller with various peripheral hardware, a custom application specific integrated circuit (ASIC), discrete electronic circuits or any other known or later-developed device or system capable of receiving voice signals from the data source and providing LPC coefficients and quantized residual signal to the communication channel 130.

The communication channel 130 can receive the LPC coefficients and quantized residual signal, and provide the various signals to the receiver 140 via link 136. The exemplary communication channel 130 is a wireless link over a cellular telephony network. However, the communication channel 130 can alternatively be a hardwired link such as a telephony T1 or E1 line, an optical link, other wireless or wired links, a sonic link or any other known or later-developed communication device or system capable of receiving LPC coefficients and residual signal information, such as a quantized residual signal from the transmitter 110, and transporting this data to the receiver 140 without departing from the spirit and scope of the present invention.

For each frame of speech, the decoder 150 can receive LPC coefficients and residual signal information from the communication channel 130, construct a filter/process using the LPC coefficients and process the respective residual signal information using the constructed filter/process to synthesize a speech signal s′[n], which can be an approximation of the original speech signal s[n]. Once reconstructed, the synthesized speech signal s′[n] can be provided to the data sink 160.

The data sink 160 can receive the synthesized speech s′[n] from the decoder 150. The exemplary data sink 160 is an electronic circuit having an digital-to-analog converter (DAC), an amplifier and speaker capable of transforming electronic signals into mechanical/acoustic signals. However, the data sink 160 alternatively can be any combination of hardware and software capable of receiving synthesized speech data such as a transponder, a computer with a storage system or any other known or later-developed device or system capable of receiving, relaying, storing, sensing or perceiving signals provided by the decoder 150.

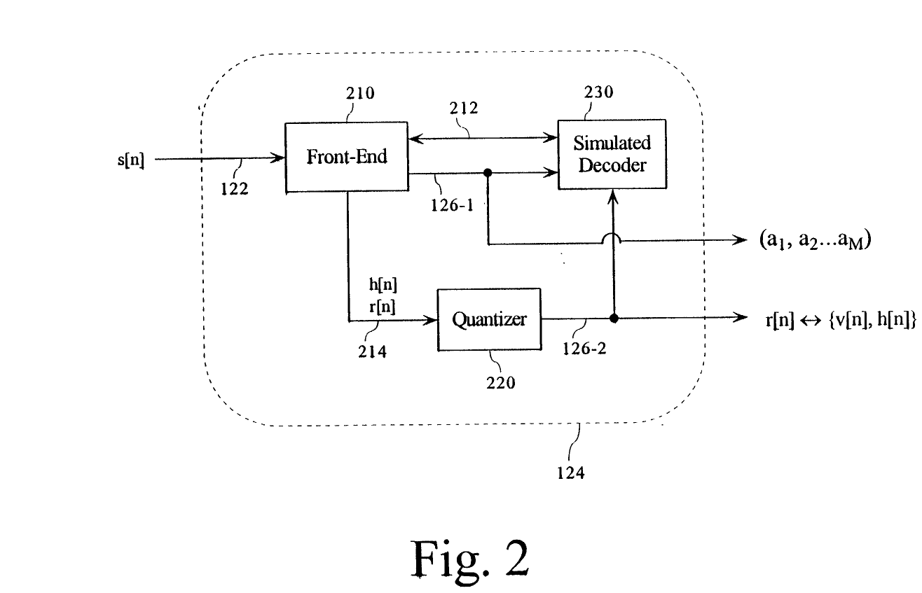

FIG. 2 is a block diagram of the exemplary coder 124 of FIG. 1. The exemplary coder 124 includes a front-end 210, a quantizer 220 and a simulated decoder 230.

In operation, the front-end 210 can receive various speech signals s[n] via link 122. The front-end 210 then can perform various processes on the received speech signals, such as framing, filtering, performing LPC analysis, performing LSP quantization, formant perceptual weighting and determining pitch estimation. Details about the various processes of the exemplary front-end 210 can be found in standardization sector of International Telecommunications Union (ITU), “Dual rate speech coder for multimedia communications transmitting at 5.3 and 6.3 kbit/s per second” (ITU-T Recommendation G.723.1) herein incorporated by reference in its entirety. While the exemplary front-end 210 operates according to the ITU-T recommendation G.723.1, it should be appreciated that the particular operations and functions of the exemplary front-end 210 can vary as desired or otherwise required by design and can include any known or later-developed combination of processes useful for encoding speech information without departing from the spirit and scope of the present invention.

As the front-end 210 performs its various processes, the front-end 210 can provide various signals to, and received signals from, the simulated decoder 230 via links 212 and 126-1, provide LPC coefficients, or equivalent information, to an external device (not shown) via link 126-1, and further provide a residual signal r[n] and impulse response h[n] to the quantizer 220 via link 214.

The simulated decoder 230 can receive various signals from the front-end 210 and the quantizer 220 and produce various signals such as synthesized LSP coefficients, which can then be provided to the front-end 210, such that the front-end 210 can estimate an impulse response h[n], which as mentioned above, can in turn be provided to the quantizer 220.

As discussed above, the quantizer 220 can receive an impulse response h[n] and residual signal r[n] and compress, or quantize, the residual signal using a synthesized excitation signal v[n] and the received impulse response h[n]. Once quantized, the quantizer 220 can provide the quantized residual signal r′[n] in the form of its constituent excitation signal and impulse response r′[n] {v[n], h[n]} to an external device such as a decoder (not shown) via link 126-2.

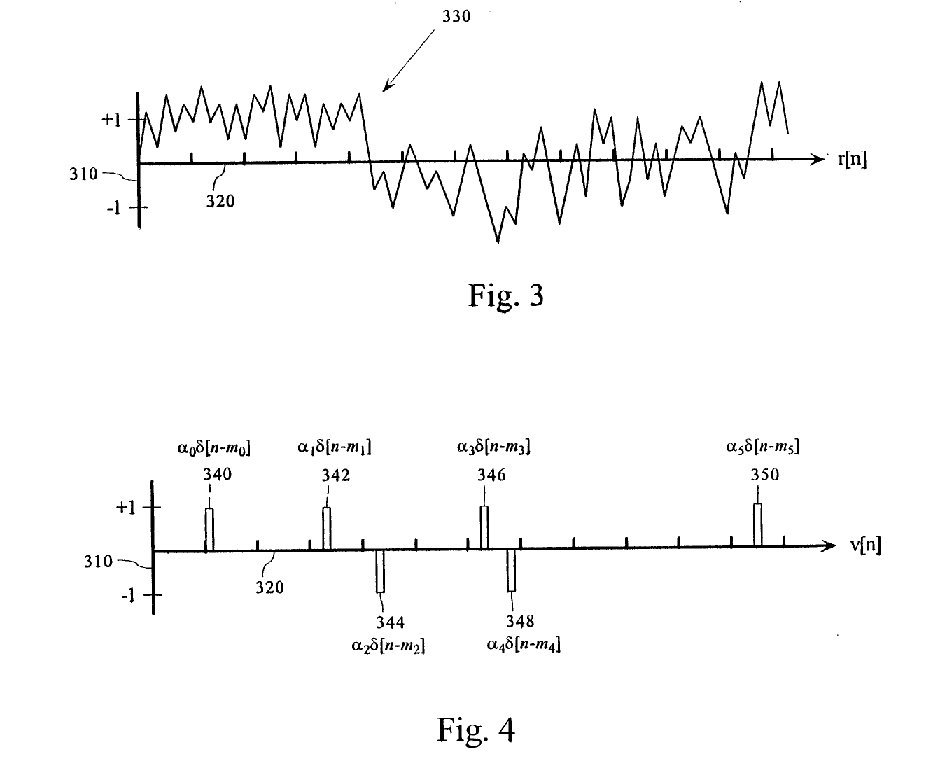

FIG. 3 depicts an exemplary residual signal 330. As shown in FIG. 3, the residual signal 330 is plotted along a time-axis 320 and against an amplitude-axis 310. The exemplary residual signal 330 contains sixty discrete values. However, it should be appreciated that the particular number of samples in a residual signal as well as the time frame covered by the residual signal can vary as required without departing from the spirit and scope of the present invention.

FIG. 4 depicts an exemplary excitation signal v[n] that, when convolved with a complimentary impulse response h[n], can represent a signal such as the residual signal of FIG. 3. As shown in FIG. 4, the excitation signal can contain six individual pulses 350-360 distributed at various points along the time-axis 320. The exemplary pulses 350-360 (denoted by aₖδ[n−mₖ], for k=0, 1, . . . , 5) have an amplitude of aₖ=±1 and can be located at positions δ[n−mₖ] where 0≦mₖ≦59 according to an MP-MLQ protocol. However, it should be appreciated that the particular number, characteristics and distribution of pulses can vary as desired or otherwise required by design without departing from the spirit and scope of the present invention.

As discussed above, once an excitation signal v[n] is synthesized, the excitation signal can be convolved with a complimentary impulse response h[n] to produced a quantized residual signal. The quantized residual signal can then be compared to a known signal, such as an original, or target, residual signal. If the difference between the quantized residual signal and the original residual signal are small enough, it should be appreciated that the excitation signal v[n] and complimentary impulse response h[n] can represent a compressed form of the original residual signal r[n].

However, if the difference between the quantized residual signal and the original residual signal increase, the excitation signal v[n] and complimentary impulse response h[n] are less capable of representing the original residual signal and thus, another combination of pulses might be better suited to represent the original residual signal.

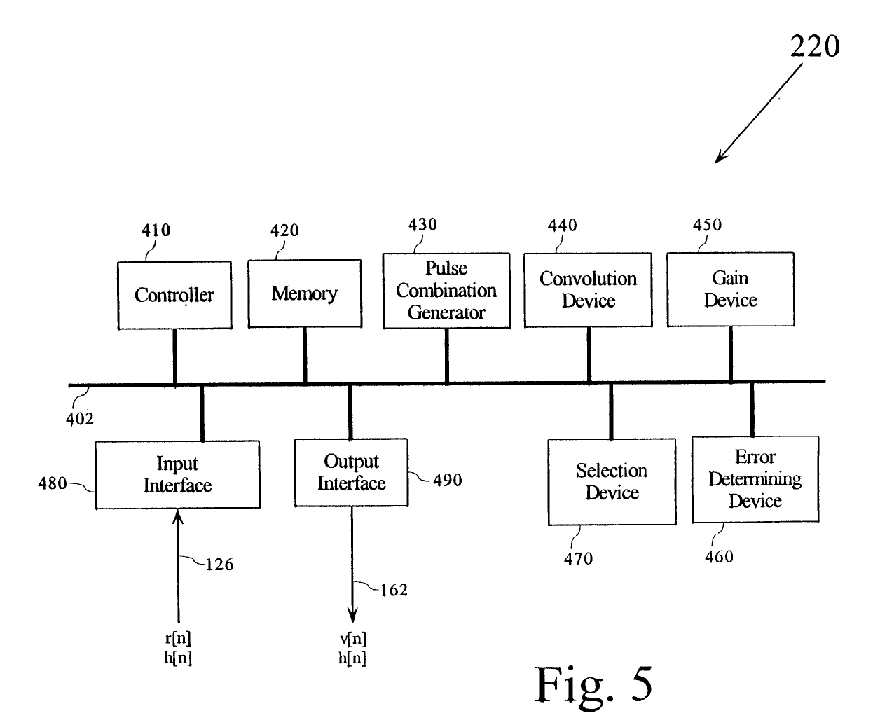

FIG. 5 is a block diagram of an exemplary quantizer 220 that can receive a residual signal and quantize the residual signal using a pulse stream having a number of pulses and a plurality of zero values. As shown in FIG. 5, the quantizer 220 includes a controller 410, a memory 420, a pulse combination generator 430, a convolution device 440, a gain device 450, an error determining device 460, a selection device 470, an input interface 480 and an output interface 490. The various components 410-490 can be coupled together using a control/databus 402. While FIG. 5 depicts a quantizer 220 realized using a bussed architecture, it should be appreciated that the quantizer 220 can be realized using various other architectures such as circuits employing discrete logic, PDAs, PALs, ASICs, FPGAs and the like.

In operation, and under control of the controller 410, the input interface 480 can receive a residual signal r[n] and complimentary impulse response signal h[n] and store the signals in the memory 420. The memory 420 stores the residual signal, complimentary impulse response signal and other data generated during processing.

In various exemplary embodiments, the residual signal contains a stream of sixty digital values according to the G.732.1 codec standard. However, it should be appreciated that the particular format of the residual signal as well as the format of the impulse response signal can vary as desired or otherwise required by design without departing from the spirit and scope of the present invention.

Next, the pulse combination generator 430 generates a pulse stream. In various embodiments, the exemplary pulse combination generator 430 can generate pulse streams according to the G.732.1 codec standard. Accordingly, in various exemplary embodiments, the pulse stream can be an MP-MLQ excitation signal containing sixty values with five or six of the values being ±1 and the remaining values being zero.

In other exemplary embodiments, the pulse combination generator 430 can generate pulse streams according to an ACELP protocol having a pulse stream of sixty values with the locations of the non-zero values determined according to a predetermined codebook. A codebook can be any predetermined set of allowable locations and/or amplitude combinations directed to a pulse stream that can be advantageous or otherwise useful to quantize signals such as a residual signal.

In still other embodiments, it should be appreciated that the pulse combination generator 430 can generate pulse streams according to any existing or later developed protocol or standard without departing from the spirit and scope of the present invention.

Consistent with a given protocol, the amplitude and placement of the pulses of pulse stream, such as an excitation signal v[n], can be determined based on a trial-and-error synthesis technique. However, the particular technique used to generate excitation signals can change as desired or otherwise required by design without departing from the spirit and scope of the present invention.

Once the pulse combination generator 430 generates an appropriate pulse stream, the pulse combination generator 430 can provide the pulse stream to the convolution device 440.

The convolution device 440 can receive the pulse stream from the pulse combination generator 430, and further receive the impulse response h[n] from the memory 420 and perform a convolution operation on the two signals. As discussed above, by performing a convolution between the pulse stream and impulse response, the convolution device 440 can synthesize a quantized residual signal r′[n] that can closely approximate the received residual signal r[n] given that the non-zero pulses in the pulse stream are appropriately placed. The exemplary convolution device 440 performs an operation according to Eq. (1):

$${r}^{′} [ n ] = {\sum }_{j = 0}^{n} h [ j ] \cdot v [ n - j ] , 0 \leq n \leq 59 \qquad ( 1 )$$

where h[n] is an impulse response, i.e., transfer function of a filter, and v[n] is an excitation signal defined by Eq. (2):

$$v [ n ] = G {\sum }_{k = 0}^{M - 1} {a}_{k} δ [ n - {m}_{k} ] , 0 \leq n \leq 59 \qquad ( 2 )$$

where G is the gain factor, M is the number of pulses in v[n], δ[n] is the Dirac (impulse) function, aₖ are the amplitudes (±1) of the Dirac pulses and {n−mₖ} are the positions of the pulses.

Unfortunately, as discussed above, conventional convolution approaches can be very computationally intensive as a large number of multiply-and-accumulate operations must be performed to determine every point in the convolved signal. Conventional convolution techniques generally involve operations outlined according to Table 1 below.

TABLE 1

| | |
|---|---|
| 1. | for (k=0; k <=1; k++) /* Grid loop */ |
| 2. | { |

| | |
|---|---|
| 3. | ./* code for finding out maximum amplitude */ |
| 4. | . |
| 5. | for (/ = 0; / <+3; /++) /* Amplitude loop */ |
| 6. | { |

| | |
|---|---|
| 7. | ./* code for finding 6/5 pulses */ |
| 8. | for (j = 59; j >= 0; j−−) /* Convolution loop */ |
| 9. | { |

| | |
|---|---|
| 10. | for (/ = 0; / <= j; /++) /* Convolution sub-loop */ |
| 11. | { |

| | |
|---|---|
| 12. | y[j] = y[j] + v[/] * h[j−/]; |

| | |
|---|---|
| 13. | } |

| | |
|---|---|
| 14. | } |

| | |
|---|---|
| 15. | } |
| 16.} | |

As shown in Table 1, the convolution loop (lines 8-14), and in particular the convolution sub-loop (lines 10-13), require that each and every relevant point in the pulse stream be multiplied with respective values in the impulse response signal regardless of the values of the excitation signal or impulse response. The computational requirements for an implementation such as that of Table 1 can be ((60×59)÷2)×4×2=14,160 cycles. For a G.723.1 speech codec, the code segment of Table 1 can be repeated six times per 30 msec frame for a total of 2.6 million cycles-per-second.

However, as discussed above, the exemplary convolution device 440 avoids unnecessary computation by strategically multiplying only non-zero values within a pulse stream. Table 2 is an exemplary code segment according to the invention capable of avoiding unnecessary computation.

TABLE 2

| | |
|---|---|
| 1. | for (k=0; k <=/; k++) /* Grid loop */ |
| 2. | { |

| | |
|---|---|
| 3. | ./* code for finding out maximum amplitude */ |
| 4. | for(i = 0; i <= 3; i++) /* Amplitude loop */ |
| 5. | { |

| | |
|---|---|
| 6. | ./* code for finding 6/5 pulses */ |
| 7. | for (j = 59; j <= 0; j−−) /* convolution loop */ |
| 8. | { |

| | |
|---|---|
| 9. | for ( /=0; / <= 5; /++) /* Convolution sub-loop */ |
| 10. | { |

| | |
|---|---|
| 11. | If(xloc[/] <= j) |

| | |
|---|---|
| 12. | y[j]=y[j]+x[xloc[/]] * h[j−xloc[/]]; |

| | |
|---|---|
| 13. | } |

| | |
|---|---|
| 14. | } |

| | |
|---|---|
| 15. | } |
| 16.} | |

As shown in Table 2, the convolution sub-loop (lines 10-13) only multiplies the non-zero values of the pulse stream, which reside at known locations. Accordingly, for a given loop, the sub-loop of Table 2 will perform only five or six multiply-and-accumulate operations, as opposed to as many as sixty multiply-and-accumulate operations of the conventional convolution technique outlined in Table 1. By performing a convolution according to Table 2, the computational intensity can be reduced by as much as 65%.

After the convolution device 440 performs a convolution to produce a quantized residual signal, the quantized residual signal is provided to the gain device 450 and error determining device 460.

The gain device 450 can receive the quantized residual signal and generate a series of complimentary gain values G based on the received quantized residual signal. While the gain device 450 generates gain values according to the G.732.1 specification, it should be appreciated that the gain device 450 can generate gain values according to any known or later developed technique without departing from the spirit and scope of the present invention. Once the gain device 450 has generated its gain values, the gain device 450 provides these values to the error determining device 460.

The error determining device 460 can receive the various gain values and the quantized residual signal as well as the original received residual signal, and perform an error calculations for the various gain values according to Eq. (3):

$$err [ n ] = r [ n ] - {r}^{′} [ n ] = r [ n ] - G {\sum }_{k = 0}^{M - 1} {a}_{k} h [ n - {m}_{k} ] \qquad ( 3 )$$

Once the error calculations are completed for the various gain values, the error determining device 460 can provide the error values err[n] and respective gain values to the selection device 470.

The selection device 470 can receive the error values and respective gain values and determine the optimum gain value Gₒₚₜ that provides the lowest squared-error for a particular pulse stream. In various embodiments, the selection device 470 can determine whether the optimum gain value produces an error value that is sufficiently small enough according to a predetermined threshold. If the optimum gain produces a sufficiently small error value, the selection device 470 can provide the optimum gain value to the controller 410, which can forward the optimum gain value Gₒₚₜ, pulse stream v[n] and impulse response h[n] to an external device such as a decoder (not shown) via the output interface 490 and link 162.

However, if the optimum gain value produces an error value that is too large, the selection device 470 can send a signal to the pulse combination device 430 to generate another pulse stream that can again be similarly processed. The cycle of generating pulse streams, convolving the pulse streams with impulse response signals, error determining and selection can then be repeated until the selection device 470 determines that a particular pulse stream can provide a quantized residual signal r′[n] sufficiently similar to the received residual signal r[n].

In other exemplary embodiments, the pulse combination device 430 can generate some or all possible pulse combinations. Accordingly, the convolution device 440, the gain device 450 and error determining device 460 can operate on the pulse streams and the selection device 470 can select the parameters, G, aₖ and mₖ for k=0, 1, . . . , M−1 that minimizes the mean square of the error signal err[n]. After the selection device 470 determines the overall best set of parameters, the selection device 470 can provide these global optimal parameters Gₒₚₜ, aₖ₋ₒₚₜ and mₖ₋ₒₚₜ to the controller 410, which can forward the global optimum gain value, global optimum pulse stream and impulse response to an external device such as a decoder (not shown) via the output interface 490 and link 162.

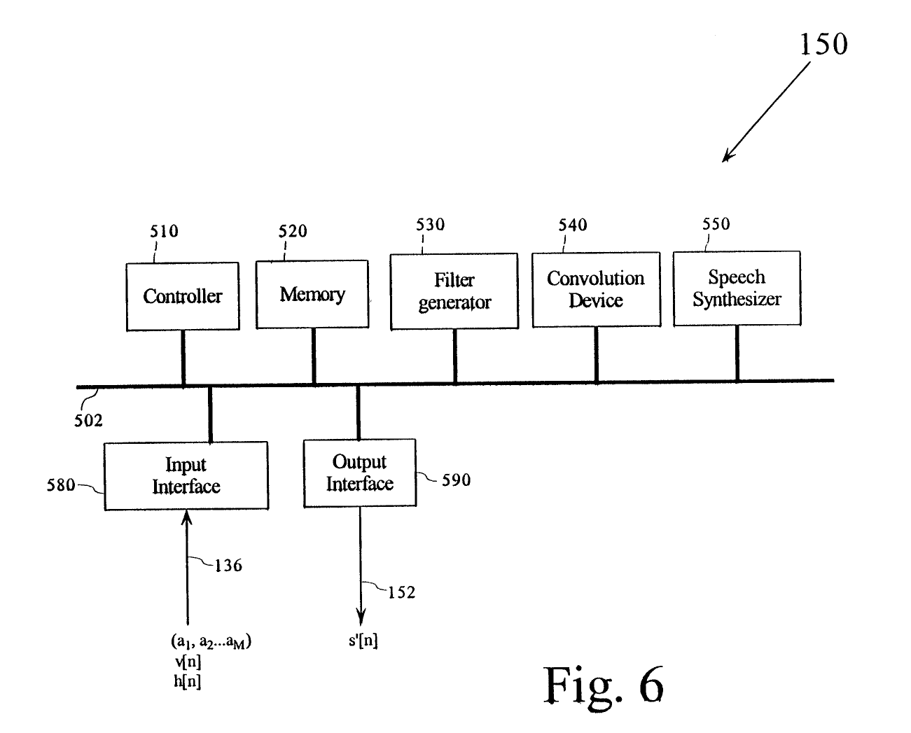

FIG. 6 is a block diagram of an exemplary decoder 150 that can receive LPC coefficients and residual information and synthesize speech. As shown in FIG. 6, the decoder 150 includes a controller 510, a memory 520, a filter generator 530, a convolution device 540, a speech synthesizer 550, an input interface 580 and an output interface 590. The various components 510-590 can be coupled together using a control/databus 502. While FIG. 6 depicts a decoder 150 realized using a bussed architecture, it should be appreciated that the decoder 150 can be realized using various other architectures such as circuits employing discrete logic, PDAs, ASICs, FPGAs and the like.

In operation, and under control of the controller 510, for a particular frame of speech, the input interface 580 can receive a pulse stream such as an excitation signal v[n], a gain signal G, an impulse response signal h[n] and a set of LPC coeffiients (a₁, a₂, . . . , a_{M}), and store the signals in the memory 420. The memory 520 stores the various received signals and other data generated during processing. Next, the controller 510 can provide the LPC coefficients to the filter generator 530, the pulse stream and impulse response to the convolution device 540 and the gain value to the speech processor 550.

The filter generator 530 can receive the LPC coefficients and generate a filter A⁻¹′[Z] based on the LPC coefficients. Once the filter A⁻¹[Z] has been generated, the filter generator 530 can provide the filter to the speech processor 550.

Additionally, the convolution device 540 can receive the pulse stream and impulse response, and perform a convolution on the two signals to generate a quantized residual signal. The exemplary convolution device 540 can convolve signals according to Table 2 by not performing multiply-and-accumulate operations on zero values in the pulse stream. However, it is to be understood that the particular convolution approach can vary without departing from the spirit and scope of the present invention. Once the convolution device 540 generates its quantized residual signal, the convolution device can provide the quantized residual signal to the speech synthesizer 550.

The speech synthesizer 550 can receive the gain value, the filter A⁻¹[Z] and the quantized residual signal and process the quantized residual signal and gain value through the filter to generate a frame of synthesized speech s′[n]. The speech processor 550 can then provide the frame of synthesized speech s′[n] to an external device (not shown) via the output interface 590 and link 152, and the decoder 150 can again receive yet another gain value, pulse stream and set of LPC coefficients for the next frame of speech.

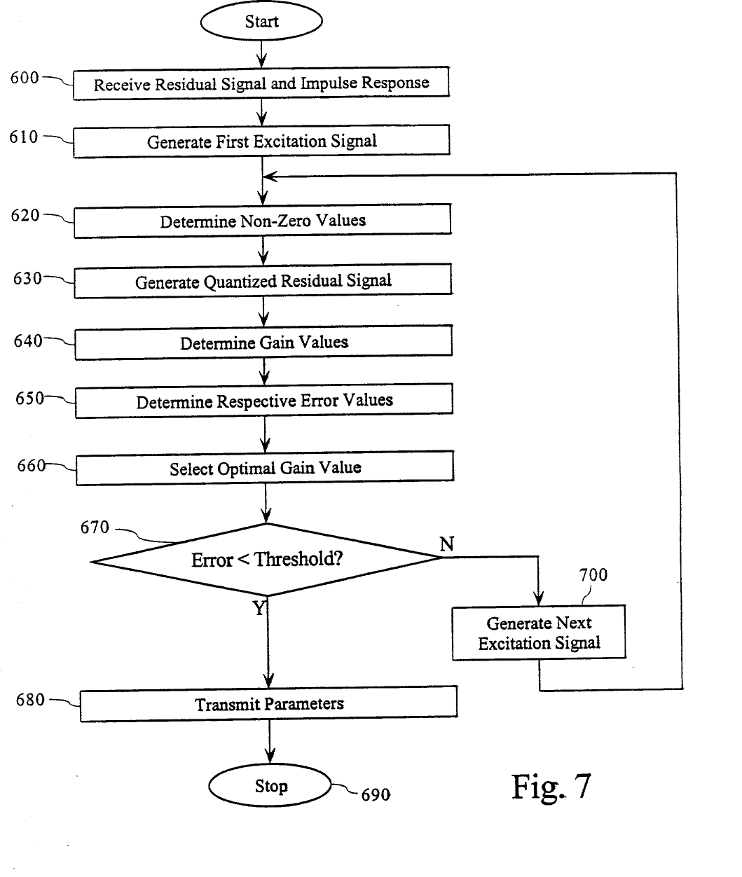

FIG. 7 is a flowchart outlining an exemplary operation for quantizing a waveform such as a codec residual signal. The operation begins in step 600 where a residual signal and complementary impulse response for a frame of speech are received. Next, in step 610, a first pulse stream, i.e., excitation signal is generated. The exemplary residual signal, impulse response and excitation signal conform to the G.732.1 codec standard. However, the formats of the residual signal, impulse response and excitation signal can vary to any known or later developed communication standard, without departing from the spirit and scope of the present invention. The process continues to step 620.

In step 620, the non-zero values of the residual signal are determined. Next, in step 630, the excitation signal and impulse response are convolved to generate a quantized residual signal. The exemplary process convolves the excitation signal and impulse response according to Table 2 above. However, it should be appreciated that any technique directed to convolving a pulse stream containing a number of non-zero values and a plurality of zero values with a second signal while avoiding one or more multiply-and-accumulate operations with the zero values of the pulse stream can be used without departing from the spirit and scope of the present invention. The process continues to step 640.

In step 640, a range of gain values are determined for the quantized residual signal. Next, in step 650, a number of respective error values for the various gain values of step 640 are determined. The exemplary error values are based on Eq. (3) above. However, it should be appreciated that the particular measure of error can vary without departing from the spirit and scope of the present invention. The process continues to step 660.

In step 660, the gain value that provides the lowest error value, i.e., the optimal gain value is selected. Next, in step 670, a determination is made whether the error value of the optimal gain is smaller than a predetermined threshold. That is, a determination is made as to whether the quantized residual signal is sufficiently similar to the received residual signal If the error value is sufficiently small, the process continues to step 680; otherwise, control jumps to step 700.

In step 680, the optimal gain value along with the excitation signal and impulse response are transmitted to a device such as a decoder. The process continues to step 690 where the process stops.

In step 700, because the respective error value of the optimal gain is not sufficiently small, another combination of pulses for another excitation signal is generated. The process then jumps back to step 620 where the new excitation signal is processed according to steps 620-700 until a quantized excitation signal is generated that sufficiently resembles the received residual signal where the process can then stop.

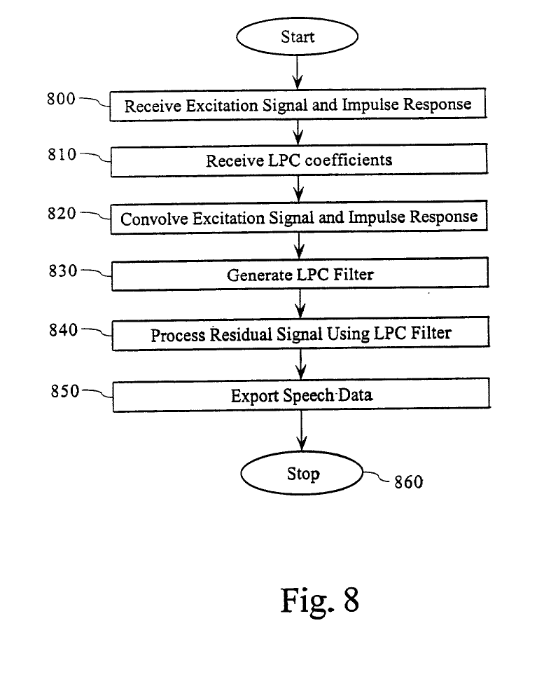

FIG. 8 is a flowchart outlining an exemplary operation for efficiently synthesizing a frame of speech. The operation begins in step 800 where a quantized residual signal including at least an excitation signal and complementary impulse response for a frame of speech are received. Next, in step 810, a set of LPC coefficients are received. The exemplary excitation signal, impulse response and LPC coefficients to the G.732.1 codec standard. However, the formats of the various signals and coefficients can vary to any known or later developed communication standard, without departing from the spirit and scope of the present invention. The process continues to step 820.

In step 820, the excitation signal and impulse response are convolved to generate a quantized residual signal. The exemplary process convolves the excitation signal and impulse response according to Table 2 above. However, it should be appreciated that any technique directed to convolving a pulse stream containing a number of non-zero values and a plurality of zero values with a second signal while avoiding one or more multiply-and-accumulate operations with the zero values of the pulse stream can be used without departing from the spirit and scope of the present invention. The process continues to step 830.

In step 830, an LPC decoder filter/process is generated based on the received LPC coefficients. Next, in step 840, the quantized residual signal generated in step 820 is process using the LPC filter of step 830 to synthesize a frame of speech. Then, in step 850, the frame of synthesized speech is exported and the process stops in step 860.

As shown in FIGS. 5 and 6, the methods of this invention are preferably implemented using a digital signal processor with peripheral integrated circuit elements and dedicated communication hardware. However, the data interface 120 can be implemented using any combination of one or more programmed special purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing the flowcharts shown in FIGS. 7 and 8 can be used to implement the quantizer of FIG. 5 or the decoder of FIG. 6 respectively.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. Thus, there are changes that may be made without departing from the spirit and scope of the invention.

What is claimed is: Double-click for Instructions

1. A method for quantizing information, comprising:
generating a first pulse stream containing at least one pulse and a plurality of zero values; and
convolving the first pulse stream with a second signal to produce a third signal, wherein the step of convolving does not multiply at least one zero value of the first pulse stream with a respective value of the second signal.

2. The method of claim 1, wherein the step of convolving does not multiply a substantial number of zero values of the first pulse stream with respective values of the second signal.

3. The method of claim 2, wherein the step of convolving does not multiply essentially all of the zero values of the first pulse stream with respective values of the second signal.

4. The method of claim 3, wherein the step of convolving only multiplies the pulses in the first pulse stream with respective values of the second signal.

5. The method of claim 4, wherein each of the pulses of the first pulse shown has a value of the one of +1 and −1.

6. The method of claim 4, wherein the quantization is based on a multipulse-maximum likelihood quantization (MP-MLQ) protocol.

7. The method of claim 4, wherein the quantization is based on an algebraic-codebook excited linear-predicted (ACELP) protocol.

8. The method of claim 4, wherein the first pulse stream is an excitation signal.

9. The method of claim 8, wherein the second signal is an impulse response.

10. A device for quantizing information, comprising:
a generator that generates at least a first pulse stream containing a number of non-zero values and plurality of zero values; and
a convolution device that convolves the first pulse stream with a second signal to produce a quantized signal;
wherein the convolution device does not multiply at least one zero value of the first pulse stream with a respective value of the second signal.

11. The device of claim 11, wherein the convolution device does not multiply a substantial number of zero values of the first pulse stream with respective values of the second signal.

12. The device of claim 12, wherein the convolution device does not multiply essentially all of the zero values of the first pulse stream with respective values of the second signal.

13. The device of claim 13, wherein the convolution device only multiplies the pulses in the first pulse stream with respective values of the second signal.

14. The device of claim 10, wherein the first pulse stream is an excitation signal.

15. The device of claim 14, wherein the second signal is an impulse response.

16. The device of claim 14, wherein the excitation signal is based on a multipulse-maximum likelihood quantization (MP-MLQ) protocol.

17. The device of claim 14, wherein the excitation signal is based on an algebraic-codebook excited linear-predicted (ACELP) technique.

18. A method for generating a communication signal, comprising:
receiving a first pulse stream containing a number of pulses and plurality of zero values;
convolving the first pulse stream with a second signal to produce the communication signal, wherein the step of convolving does not multiply at least one zero value of the first pulse stream with a respective value of the second signal.

19. The method of claim 18, wherein the step of convolving does not multiply essentially all of the zero values of the first pulse stream with respective values of the second signal.

20. The method of claim 19, wherein the step of convolving only multiplies the pulses in the first pulse stream with respective values of the second signal.

21. The method of claim 20, wherein the first pulse stream is an excitation signal and the second signal is an impulse response.

22. The method of claim 20, wherein the communication signal is a residual signal.

23. A device for generating a communication signal, comprising:
a convolution device that convolves a first pulse stream with a second signal to produce the convolved signal, wherein the first pulse stream at least one pulse and a plurality of zero values; and
a speech processor that processes the convolved signal using a filter to generate the communication signal;
wherein the convolution device does not multiply at least one zero value of the first pulse stream with a respective value of the second signal.

24. The device of claim 23, wherein the convolution device does not multiply essentially all of the zero values of the first pulse stream with respective values of the second signal.

25. The device of claim 24, wherein the convolution device only multiplies the pulses in the first pulse stream with respective values of the second signal.

26. The device of claim 25, wherein the first pulse stream is an excitation signal and the second signal is an impulse response.

27. The device of claim 25, wherein the communication signal is a residual signal.
